(19) United States
(12) Patent Application Publication
(10) Pub. No.: US 2016/0368804 A1
(43) Pub. Date: Dec. 22, 2016

(54) ENERGY-SAVING PURIFICATION SYSTEM OF HIGH-TEMPERATURE ORGANIC LIQUIDS

(71) Applicant: LI-CHU SHIH, NEW TAIPEI CITY (TW)

(72) Inventors: CHIN-CHUNG WANG, NEW TAIPEI CITY (TW); HSIAO-LUN WANG, NEW TAIPEI CITY (TW)

(73) Assignee: LI-CHU SHIH, NEW TAIPEI CITY (TW)

(21) Appl. No.: 14/801,921

(22) Filed: Jul. 17, 2015

(30) Foreign Application Priority Data
Jun. 18, 2015 (TW) 104119766

(51) Int. Cl. C02F 11/12

(52) U.S. Cl. CPC C02F 11/12; C02F 2209/03; C02F 2303/06

(57) ABSTRACT

An energy-saving purification system of high-temperature organic liquids primarily uses the physical phenomenon “the smaller the ambient pressure, the lower the boiling point of a liquid” to fine-tune and control a negative-pressure generating device timely by a temperature-pressure correspondence control device to generate a corresponsive negative-pressure gas source, so as to continue boiling, vaporizing and dewatering a low-concentration high-temperature organic liquid without a continual heating process.

### TECHNICAL FIELD

The technical field relates to an energy-saving purification system of high-temperature organic liquids, and more particularly to the purification system applicable for increasing the concentration of organic liquids and purifying the organic liquids to a level in compliance with standard concentration.

### BACKGROUND

Various types of wastes such as household food wastes, industrial wastes, sewage sludge, agricultural wastes, animal excreta, etc have a rich content of organic substances which is the main cause of producing smelly garbage and disease vectors. Therefore, the practice of separating, recycling and processing organic wastes and other wastes not just overcomes the environmental pollution problem only, but also reduces the burden of incinerators and landfills.

Since the traditional way of recycling organic wastes by the fermentation of the organic wastes to produce fertilizers not just takes much time for the process, breeds mosquitoes, produces smells and causes a secondary pollution to the environment only, but also fails to eliminate harmful elements including pests, bacteria, heavy metals and toxics in the organic wastes effectively, results in soil pollutions and harmful agricultural product, and jeopardizes our health through the food chain. In view of the aforementioned problems, the inventor of this disclosure conducted researches and developed an “Organic compound pryolysis flashover energy-saving regeneration treatment system” (Application Nos.: CN202741414U, TW 101121112, and US20140037507A1) capable of separating and processing an organic compound, and then producing liquid and solid regenerated organic compounds to be used as organic fertilizer or feed for livestock farming. Besides generating a green energy source effectively, this system also achieves the effects of recycling resources, purifying the environment, saving energy, reducing carbon, recycle and reuse.

However, the inventor of this disclosure further discovered that the high-temperature concentration of an organic liquid separated and produced by the organic compound regeneration treatment system requires a purification process to meet with the requirement of the standard concentration of the liquid organic product. Now, if the traditional concentration method by heating (or heating method) is used to maintain the low-concentration organic liquid in a boiling status at constant temperature and pressure to vaporize and reduce the moisture in the organic liquid in order to increase the concentration of the liquid, such method will consume a large amount of energy sources and purification cost. Obviously, such cost-ineffective method violates the global trend of energy saving and carbon reduction.

In view of the aforementioned problems, this disclosure discloses an energy-saving method for vaporizing the moisture of a low-concentration high-temperature organic liquid effectively and purifying the organic liquid to a liquid organic product in compliance with a standard concentration automatically.

### SUMMARY

Therefore, it is a primary objective of this disclosure to provide an energy-saving purification system of high-temperature organic liquids that primarily uses the physical phenomenon “the smaller the ambient pressure, the lower the boiling point of a liquid” and a temperature-pressure correspondence control device to detect a temperature change of the low-concentration high-temperature organic liquid to fine tune and control an ambient pressure in the purification space where the low-concentration high-temperature organic liquid is situated according to the temperature change, so as to continue boiling, vaporizing and dewatering the low-concentration high-temperature organic liquid without a continual heating process and automatically purify the liquid organic product to a level in compliance with the standard concentration.

To overcome the problems of consuming too much energy and cost to continue the boiling and vaporization by heat as adopted in the prior art, a purification operation applicable for various organic substance processing systems used in different industries to separate and produce a low-concentration high-temperature organic liquid, the purification system further recycles and separates the vaporization heat discharged in the purification process into a waste heat solution and a waste heat gas, wherein the waste heat solution is provided for mixing water with the upstream materials to achieve the effect of saving water consumption, and the waste heat gas is provided for preheating the upstream material to achieve the energy saving and carbon reduction effects.

To achieve the aforementioned and other objectives, this disclosure provides an energy-saving purification system of high-temperature organic liquids comprising: a closed pressure-regulated vaporization device, having a purification space formed therein for storing a fixed quantity of a low-concentration high-temperature organic liquid; a vaporization heat recycling device, communicated to a closed pressure-regulated vaporization device, for recycling and separating a vaporization heat discharged in a low-concentration high-temperature organic liquid purification process into a waste heat solution and a waste heat gas; a negative-pressure generating device, communicated to the vaporization heat recycling device, and further communicated to the closed pressure-regulated vaporization device through the vaporization heat recycling device, for receiving a fine-tune control to generate a negative-pressure gas source to be supplied to the purification space of the closed pressure-regulated vaporization device to perform a pressure reduction of an ambient pressure; and a temperature-pressure correspondence control device, for detecting a temperature change of the low-concentration high-temperature organic liquid and an ambient pressure of the purification space inside the closed pressure-regulated vaporization device and collecting, computing and processing the temperature change and the ambient pressure to fine-tune and control a negative-pressure gas source generated by the negative-pressure generating device, so as to control the ambient pressure of the purification space inside the closed pressure-regulated vaporization device and driving the low-concentration high-temperature organic liquid to maintain its boiling, vaporizing and dewatering without heating in the vaporizing, energy consuming and cooling statuses.

It is noteworthy that the energy-saving purification system of high-temperature organic liquids of this disclosure may be used together with any system of producing liquid organic products in different industries, and the basic condition is that the low-concentration organic liquid entering into the closed pressure-regulated vaporization device is situated at a high-temperature status (which is the low-concentration high-temperature organic liquid).

For independent operations, this energy-saving purification system further comprises: an organic material preparation unit for mixing water with an organic material and preheating the organic material; and an organic substance processing unit coupled to a downstream end of the organic material preparation unit for heating, steaming and processing the organic material, and the upstream end of the organic substance processing unit is coupled to the closed pressure-regulated vaporization device, so that the low-concentration organic liquid entering into the closed pressure-regulated vaporization device is situated at a high-temperature status, so as to form the low-concentration high-temperature organic liquid.

The aforementioned system can overcome the problems of consuming too much energy and cost to continue the boiling and vaporization by heat as adopted in the prior art, and the system is applicable for a purification operation of various organic substance processing systems used in different industries to separate and produce a low-concentration high-temperature organic liquid. Obviously, the system has a very high industrial value. In addition, the vaporization heat discharged in the purification process can be recycled and separated into a waste heat solution and a waste heat solution, and the waste heat solution is provided for mixing water with the upstream materials, and the waste heat gas is provided for preheating the upstream material, so as to achieve the energy-saving and carbon reduction effects.

Compared with the prior art, the purification system of this disclosure uses the physical phenomenon “the smaller the ambient pressure, the lower the boiling point of a liquid” to fine-tune and control a negative-pressure generating device timely by a temperature-pressure correspondence control device to generate a corresponsive negative-pressure gas source, so as to continue boiling, vaporizing and dewatering a low-concentration high-temperature organic liquid without continual heating in the vaporizing, energy consuming and cooling statuses. The purification system of this disclosure automatically purifies the liquid organic products to a level in compliance with the standard concentration and skips the conventional heating process used for the continual boiling and vaporization so as to reduce the energy consumption and cost. Obviously, such purification system has a very high industrial value. In addition, the purification system of this disclosure recycles and separates the vaporization heat discharged in the purification process into a waste heat solution and a waste heat gas to be supplied to the upstream organic material preparation unit for the purposes of water mixing and preheating, so as to achieve the energy saving and environmental protection effects.

### BRIEF DESCRIPTION OF THE DRAWINGS

FIG. 1 is a schematic view of an exemplary embodiment of a purification system of this disclosure.

### DESCRIPTION OF THE PREFERRED EMBODIMENTS

The technical content of this disclosure will become apparent with the detailed description of preferred embodiments and the illustration of related drawings as follows.

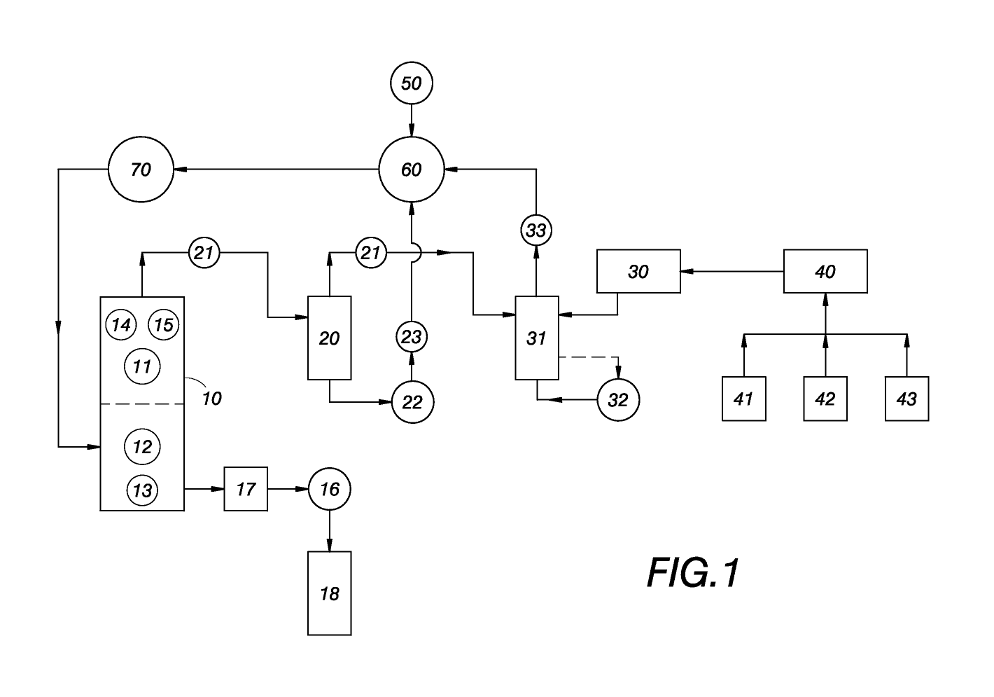

With reference to FIG. 1 for an energy-saving purification system of high-temperature organic liquids of this disclosure, the purification system comprises: a closed pressure-regulated vaporization device 10, a vaporization heat recycling device 20, a negative-pressure generating device 30, and a temperature-pressure correspondence control device 40.

The closed pressure-regulated vaporization device 10 has a purification space 11 formed therein and provided for storing a fixed quantity of low-concentration high-temperature organic liquid 12. In an embodiment, the closed pressure-regulated vaporization device 10 further comprises: a temperature detector 13 for detecting a temperature change of the low-concentration high-temperature organic liquid 12 in the closed pressure-regulated vaporization device 10, a pressure detector 14 for detecting an ambient pressure of the purification space 11 in the closed pressure-regulated vaporization device 10, a liquid level detector 15 for detecting a change of liquid level of the low-concentration high-temperature organic liquid 12 in the closed pressure-regulated vaporization device 10, a finished product extractor 16, and a finished product storage tank 18 for storing a liquid organic product 17; wherein, the liquid level detector 15 has a detection value used as a basis for controlling the purification concentration of the low-concentration high-temperature organic liquid 12; and if the liquid level of the low-concentration high-temperature organic liquid 12 drops gradually to a set target due to its boiling, vaporization and dewatering, the finished product extractor 16 will transmit the purified liquid organic product 17 to the finished product storage tank 18 for storage.

The vaporization heat recycling device 20 is communicated to the closed pressure-regulated vaporization device 10 and provided for recycling and separating the vaporization heat discharged in the purification process of the low-concentration high-temperature organic liquid 12 into a waste heat solution and a waste heat gas. In an embodiment, the vaporization heat recycling device 20 further comprises: one or more vacuuming pipes 21, a waste heat solution extractor 22, and a waste heat solution conveying pipe 23. Wherein, the waste heat solution extractor 22 is provided for transmitting the waste heat solution recycled and separated by the vaporization heat recycling device 20 to an organic material preparation unit 60 (which will be described later) through the waste heat solution conveying pipe 23 and used for mixing water and recycling raw materials.

The negative-pressure generating device 30 is communicated to the vaporization heat recycling device 20 and further communicated to the closed pressure-regulated vaporization device 10 through the vacuuming pipe 21 of the vaporization heat recycling device 20 for receiving a fine-tune control to generate a negative-pressure gas source to be supplied into the purification space 11 of closed pressure-regulated vaporization device 10 to perform a pressure reduction of the ambient pressure. In an embodiment, the negative-pressure generating device 30 further comprises: one or more vacuum pumps 31, one or more sealing liquid coolers 32, and one or more waste heat gas delivery pipes 33. Wherein, the vacuum pump 31 may be an inverter type pump or a fixed speed type pump, and the sealing liquid cooler 32 supplies a low-temperature sealing liquid to the vacuum pumps 31 to enhance the operation efficiency and service life of the negative-pressure generating device 30; and the negative-pressure generating device 30 draws and discharges the waste heat gas from the vaporization heat recycling device 20 into an organic material preparation unit 60 (which will be described later) through the waste heat gas delivery pipe 33 and the waste heat gas is used for preheating and recycling the raw materials.

The temperature-pressure correspondence control device 40 is provided for accurately detecting a temperature change of the low-concentration high-temperature organic liquid 12, and an ambient pressure of the purification space 11 inside the closed pressure-regulated vaporization device 10, and collecting, computing and processing the temperature change and the ambient pressure to fine tune and control the negative-pressure gas source generated by the negative-pressure generating device 30, so as to control the ambient pressure of the purification space 11 inside the closed pressure-regulated vaporization device 10 and driving the low-concentration high-temperature organic liquid 12 to maintain its boiling, vaporizing and dewatering without heating in the vaporizing, energy consuming and cooling statuses. In an embodiment, the temperature-pressure correspondence control device 40 further comprises an instrumental electric control panel 41, a remote monitoring device 42, and a processor 43, and the processor 43 may be a programmable logic controller (PLC) or a microprocessor (CPU or MCU).

In an embodiment, the temperature detector 13 and the pressure detector 14 installed in the closed pressure-regulated vaporization device 10 are electrically coupled to the processor 43 of the temperature-pressure correspondence control device 40, and the processor 43 is provided for collecting, computing and processing a temperature value of the low-concentration high-temperature organic liquid 12 detected by the temperature detector 13, and an ambient pressure value of the purification space 11 where the low-concentration high-temperature organic liquid 12 is situated and detected synchronously by the pressure detector 14, and then automatically transmitting a message to an instrumental electric control panel 41 and/or a remote monitoring device 42 to fine tune and control a negative-pressure gas source generated by the negative-pressure generating device 30, so as to control the ambient pressure of the purification space 11 inside the closed pressure-regulated vaporization device 10, and driving the low-concentration high-temperature organic liquid 12 to continue its boiling, vaporization and dewatering without heating in the vaporizing, power consuming, and cooling statuses.

It is noteworthy that the energy-saving purification system may be used together with any system for producing liquid organic products. The basic condition is that the low-concentration organic liquid entering into the closed pressure-regulated vaporization device 10 is situated at a high-temperature status, so that the low-concentration high-temperature organic liquid 12 stored in the closed pressure-regulated vaporization device 10 can be produced.

For independent operations, the energy-saving system of this embodiment comprises the closed pressure-regulated vaporization device 10, the vaporization heat recycling device 20, the negative-pressure generating device 30 and the temperature-pressure correspondence control device 40 and further comprises an organic material preparation unit 60 for mixing water with an organic material 50 and preheating the organic material 50, and an organic substance processing unit 70 coupled to a downstream end of the organic material preparation unit 60 for heating, steaming and processing the organic material 50, and a downstream end of the organic substance processing unit 70 is coupled to the closed pressure-regulated vaporization device 10, so that the low-concentration organic liquid entering into the closed pressure-regulated vaporization device 10 is situated at a high-temperature status. In other words, the low-concentration high-temperature organic liquid 12 stored in the closed pressure-regulated vaporization device 10 can be produced.

What is claimed is:

1. An energy-saving purification system of high-temperature organic liquids, comprising:
a closed pressure-regulated vaporization device, having a purification space formed therein for storing a fixed quantity of a low-concentration high-temperature organic liquid;
a vaporization heat recycling device, communicated to a closed pressure-regulated vaporization device, for recycling and separating a vaporization heat discharged in a low-concentration high-temperature organic liquid purification process into a waste heat solution and a waste heat gas;
a negative-pressure generating device, communicated to the vaporization heat recycling device, and further communicated to the closed pressure-regulated vaporization device through the vaporization heat recycling device, for receiving a fine-tune control to generate a negative-pressure gas source to be supplied to the purification space of the closed pressure-regulated vaporization device to perform a pressure reduction of an ambient pressure; and
a temperature-pressure correspondence control device, for detecting a temperature change of the low-concentration high-temperature organic liquid and an ambient pressure of the purification space inside the closed pressure-regulated vaporization device and collecting, computing and processing the temperature change and the ambient pressure to fine-tune and control a negative-pressure gas source generated by the negative-pressure generating device, so as to control the ambient pressure of the purification space inside the closed pressure-regulated vaporization device and driving the low-concentration high-temperature organic liquid to maintain its boiling, vaporizing and dewatering without heating in the vaporizing, energy consuming and cooling statuses.

2. The energy-saving purification system of high-temperature organic liquids as claimed in claim 1, wherein the closed pressure-regulated vaporization device further comprises: a temperature detector, for detecting the temperature change of the low-concentration high-temperature organic liquid in the closed pressure-regulated vaporization device, and a pressure detector, for detecting the ambient pressure in the purification space of the closed pressure-regulated vaporization device, and the temperature-pressure correspondence control device further comprises: an instrumental electric control panel, a remote monitoring device, and a processor; and the temperature detector and the pressure detector of the closed pressure-regulated vaporization device are electrically coupled to the processor of the temperature-pressure correspondence control device, and the processor is provided for collecting, computing and processing the temperature value of the low-concentration high-temperature organic liquid detected by the temperature detector and the ambient pressure value of the purification space where the low-concentration high-temperature organic liquid is situated and detected by the pressure detector and then automatically transmitting a message to the instrumental electric control panel and/or remote monitoring device to fine tune and control the negative-pressure gas source generated by the negative-pressure generating device.

3. The energy-saving purification system of high-temperature organic liquids as claimed in claim 1, wherein the negative-pressure generating device further comprises: one or more vacuum pumps driven by the temperature-pressure correspondence control device, and one or more sealing liquid coolers for supplying a low-temperature sealing liquid to the vacuum pumps to enhance the operation efficiency and extend the service life of the negative-pressure generating device.

4. The energy-saving purification system of high-temperature organic liquids as claimed in claim 1, wherein the closed pressure-regulated vaporization device further comprises: a liquid level detector for detecting a change of liquid level of the low-concentration high-temperature organic liquid, a finished product extractor, and a finished product storage tank; the liquid level detector has a detection value used as a basis for controlling the purification concentration of the low-concentration high-temperature organic liquid; such that when the liquid level of the low-concentration high-temperature organic liquid drops to a set target due to the boiling, vaporization and dewatering, the finished product extractor transmits the purified liquid organic product to the finished product storage tank for storage.

5. An energy-saving purification system of high-temperature organic liquids, comprising:
an organic material preparation unit, provided for mixing water and preheating an organic material;
an organic substance processing unit, coupled to a downstream end of the organic material preparation unit, and provided for heating, steaming, and processing the organic material;
a closed pressure-regulated vaporization device, coupled to a downstream end of the organic substance processing unit, and having a purification space formed therein for storing a fixed quantity of a low-concentration high-temperature organic liquid;
a vaporization heat recycling device, communicated to the closed pressure-regulated vaporization device for recycling and separating the vaporization heat discharged in the purification process of the low-concentration high-temperature organic liquid into a waste heat solution and a waste heat gas, and transmitting the waste heat solution and the waste heat gas to the organic material preparation unit for recycle and reuse;
a negative-pressure generating device, communicated to the vaporization heat recycling device, and further communicated to the closed pressure-regulated vaporization device through the vaporization heat recycling device for receiving a fine-tune control to generate a negative-pressure gas source to be supplied to the purification space inside the closed pressure-regulated vaporization device to perform a pressure reduction of the ambient pressure; and
a temperature-pressure correspondence control device, for accurately detecting a temperature change of the low-concentration high-temperature organic liquid, and an ambient pressure of the purification space inside the closed pressure-regulated vaporization device, and collecting, computing and processing the temperature change and ambient pressure to fine tune and control the negative-pressure gas source generated by the negative-pressure generating device, so as to control the ambient pressure of the purification space inside the closed pressure-regulated vaporization device to drive the low-concentration high-temperature organic liquid to continue its boiling, vaporization, and dewatering process without heating in the vaporizing, energy consuming and cooling statuses.

6. The energy-saving purification system of high-temperature organic liquids as claimed in claim 5, wherein the closed pressure-regulated vaporization device further comprises: an instrumental electric control panel, a remote monitoring device, and a processor; and the temperature detector and the pressure detector of the closed pressure-regulated vaporization device are electrically coupled to the processor of the temperature-pressure correspondence control device, and the processor is provided for collecting, computing and processing the temperature value of the low-concentration high-temperature organic liquid detected by the temperature detector and the ambient pressure value of the purification space where the low-concentration high-temperature organic liquid is situated and detected by the pressure detector and then automatically transmitting a message to the instrumental electric control panel and/or remote monitoring device to fine tune and control the negative-pressure gas source generated by the negative-pressure generating device.

7. The energy-saving purification system of high-temperature organic liquids as claimed in claim 5, wherein the negative-pressure generating device further comprises: one or more vacuum pumps driven by the temperature-pressure correspondence control device, and one or more sealing liquid coolers for supplying a low-temperature sealing liquid to the vacuum pumps to enhance the operation efficiency and extend the service life of the negative-pressure generating device.

8. The energy-saving purification system of high-temperature organic liquids as claimed in claim 5, wherein the closed pressure-regulated vaporization device further comprises: a liquid level detector for detecting a change of liquid level of the low-concentration high-temperature organic liquid, a finished product extractor, and a finished product storage tank; the liquid level detector has a detection value used as a basis for controlling the purification concentration of the low-concentration high-temperature organic liquid; such that when the liquid level of the low-concentration high-temperature organic liquid drops to a set target due to the boiling, vaporization and dewatering, the finished product extractor transmits the purified liquid organic product to the finished product storage tank for storage.

9. An energy-saving purification system of high-temperature organic liquids, comprising:
a closed pressure-regulated vaporization device, having a purification space formed inside the closed pressure-regulated vaporization device and provided for storing a fixed quantity of a low-concentration high-temperature organic liquid;
and the closed pressure-regulated vaporization device further comprising: a temperature detector, for detecting a temperature change of the low-concentration high-temperature organic liquid in the closed pressure-regulated vaporization device, a pressure detector, for detecting the ambient pressure in the purification space of the closed pressure-regulated vaporization device, a liquid level detector for detecting a change of liquid level of the low-concentration high-temperature organic liquid, a finished product extractor, and a finished product storage tank;
a vaporization heat recycling device, communicated to the closed pressure-regulated vaporization device, for recycling and separating a vaporization heat discharged in a low-concentration high-temperature organic liquid purification process into a waste heat solution and a waste heat gas; and the gas-liquid separating device further comprising: one or more vacuuming pipes, a waste heat solution extractor, and a waste heat solution conveying pipe;
a negative-pressure generating device, communicated to the vaporization heat recycling device, and further communicated to the closed pressure-regulated vaporization device through the vacuuming pipe for receiving a fine-tune control to generate a negative-pressure gas source to be supplied to the purification space inside the closed pressure-regulated vaporization device to perform a pressure reduction operation of the ambient pressure; and the negative-pressure generating device further comprising: one or more vacuum pumps, one or more sealing liquid coolers, and one or more waste heat gas delivery pipes;
a temperature-pressure correspondence control device, for accurately detecting a temperature change of the low-concentration high-temperature organic liquid, and an ambient pressure of the purification space inside the closed pressure-regulated vaporization device, and collecting, computing and processing the temperature change and ambient pressure to fine tune and control the negative-pressure gas source generated by the negative-pressure generating device, so as to control the ambient pressure of the purification space inside the closed pressure-regulated vaporization device to drive the low-concentration high-temperature organic liquid to continue its boiling, vaporization, and dewatering process without heating in the vaporizing, energy consuming and cooling statuses; and the temperature-pressure correspondence control device further comprising: an instrumental electric control panel, a remote monitoring device, and a processor, and the processor being electrically coupled to the temperature detector, the pressure detector, the liquid level detector, and the finished product extractor.

10. The energy-saving purification system of high-temperature organic liquids as claimed in claim 9, further comprising: an organic material preparation unit for mixing water with an organic material and preheating the organic material; an organic substance processing unit coupled to a downstream end of the organic material preparation unit and provided for heating, steaming, and processing the organic material to form a low-concentration high-temperature organic liquid to be transmitted to the closed pressure-regulated vaporization device.
